(19) United States
(12) Patent Application Publication
(10) Pub. No.: US 2011/0006047 A1
(43) Pub. Date: Jan. 13, 2011

(54) METHOD AND SYSTEM FOR MONITORING AND CHARACTERIZING THE CREATION OF A MANUAL WELD

(76) Inventors: VICTOR MATTHEW PENROD, HILLIARD, OH (US); CONSTANCE T. REICHERT LAMORTE, COLUMBUS, OH (US); PAUL C. BOULWARE, COLUMBUS, OH (US); CHRISTOPHER C. CONRARDY, COLUMBUS, OH (US)

Correspondence Address: MCNEES WALLACE & NURICK LLC, 100 PINE STREET, P.O. BOX 1166, HARRISBURG, PA, 17108-1166, US

(21) Appl. No.: 12/499,687

(22) Filed: Jul. 8, 2009

(51) Int. Cl. B23K 9/095; G09B 25/02

(52) U.S. Cl. 219/137 R; 434/234

(57) ABSTRACT

A method and system for monitoring and characterizing the creation of a manual weld is disclosed. The system generally includes a welding gun having a target, an imaging system, a processor, and a display. During the creation of a manual weld, the imaging system captures a plurality of images of the target. The processor analyzes the plurality of images of the target to calculate a plurality of position and orientation characteristics associated with the manipulation of the welding gun during the welding process. The display illustrates at least one of the plurality of position and orientation characteristics to provide feedback regarding the creation of the weld. In one embodiment, the disclosed method and system may be utilized as a tool for training welders.

### CROSS-REFERENCE TO RELATED APPLICATIONS

Not Applicable.

### STATEMENT REGARDING FEDERALLY SPONSORED RESEARCH OR DEVELOPMENT

Not Applicable.

### TECHNICAL FIELD

The present disclosure relates to welding, and more particularly, to a method and system for monitoring and characterizing the creation of a manual weld.

### BACKGROUND OF THE INVENTION

The manufacturing industry's desire for efficient and economical welder training has been a well documented topic over the past decade as the realization of a severe shortage of skilled welders is becoming alarmingly evident in today's factories, shipyards, and construction sites. A rapidly retiring workforce, in concurrence with the slow pace of traditional instructor-based welder training has been the impetus for the development of more effective training technologies. Innovations which allow for the accelerated training of the manual dexterity skills specific to welding, along with the speedy indoctrination of arc welding fundamentals are becoming a necessity. The method and system for monitoring and characterizing the creation of a manual weld disclosed herein addresses this vital need for improved welder training and enables the monitoring of manual production welding processes to ensure the processes are within allowable limits necessary to meet quality requirements. To date the majority of welding processes are performed manually, yet the field is lacking practical commercial tools to track the performance of these manual processes.

### SUMMARY OF THE INVENTION

In its most general configuration, the method and system for monitoring and characterizing the creation of a manual weld advances the state of the art with a variety of new capabilities and overcomes many of the shortcomings of prior methods and systems in new and novel ways. In its most general sense, the method and system overcome the shortcomings and limitations of the prior art in any of a number of generally effective configurations.

Disclosed herein is a method and system for monitoring and characterizing the creation of a manual weld. The system generally includes a welding gun having a target, an imaging system, a processor, and a display. During the creation of a manual weld, the imaging system captures a plurality of images of the target. The processor analyzes the plurality of images of the target to calculate a plurality of position and orientation characteristics associated with the manipulation of the welding gun during the welding process. The display illustrates at least one of the plurality of position and orientation characteristics to provide feedback regarding the creation of the weld.

In one embodiment, the associated method begins by positioning a welding gun having a target in proximity to a weld joint. Next, the welding gun is used to weld along the weld joint. As the welding gun traverses the weld joint, a plurality of images of the target are captured remotely. The next step includes processing the plurality of remotely captured images of the target to calculate a plurality of position and orientation characteristics associated with the manipulation of the welding gun during welding. The method concludes by displaying at least one of the plurality of position and orientation characteristics associated with the manipulation of the welding gun during welding.

Numerous alterations, modifications, and variations of the preferred embodiments disclosed herein will be apparent to those skilled in the art and they are all anticipated and contemplated to be within the spirit and scope of the method and system.

### BRIEF DESCRIPTION OF THE DRAWINGS

Without limiting the scope of the method and system for monitoring and characterizing the creation of a manual weld as claimed below and referring now to the drawings and figures:

FIG. 1 shows a perspective view of an embodiment of a system for monitoring and characterizing the creation of a manual weld, not to scale;

FIG. 2 shows a side elevation view of an embodiment of a system for monitoring and characterizing the creation of a manual weld, not to scale;

FIG. 3 shows a front elevation view of an embodiment of a system for monitoring and characterizing the creation of a manual weld, not to scale;

FIG. 4 shows a graphical display of three position and orientation characteristics associated with the manipulation of a welding gun during welding, not to scale; and

FIG. 5 shows a flow chart of an embodiment of a method for monitoring and characterizing the creation of a manual weld.

These drawings are provided to assist in the understanding of the exemplary embodiments of the method and system for monitoring and characterizing the creation of a manual weld as described in more detail below and should not be construed as unduly limiting the method and system. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The claimed method and system (100) for monitoring and characterizing the creation of a manual weld enables a significant advance in the state of the art. The preferred embodiments of the method and system (100) accomplish this by new and novel arrangements of elements and methods that are configured in unique and novel ways and which demonstrate previously unavailable but preferred and desirable capabilities. The description set forth below in connection with the drawings is intended merely as a description of the presently preferred embodiments of the method and system (100), and is not intended to represent the only form in which the method and system (100) may be utilized or constructed. The description sets forth the designs, functions, means, and methods of implementing the method and system (100) in connection with the illustrated embodiments. It is to be understood, however, that the same or equivalent functions and features may be accomplished by different embodiments that are also intended to be encompassed within the spirit and scope of the claimed method and system (100).

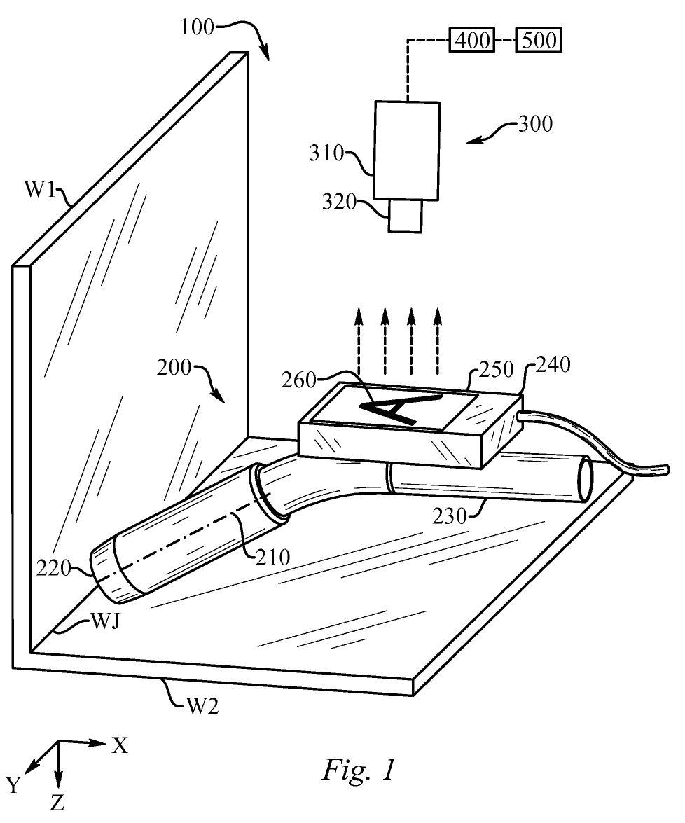

With general reference to FIGS. 1-3, a system (100) for monitoring and characterizing the creation of a manual weld is illustrated. The system (100) generally includes a welding gun (200), an imaging system (300), a processor (400), and a display (500). The system (100) has a number of applications, including but not limited to, welding training, “dry-run” welding training, process monitoring, process control, correlation to mechanical properties to reduce or eliminate destructive testing, and real-time feedback while creating a manual weld. Thus, references herein to the “welding” of various work pieces includes simulated welding, training welding, and “dry-run” welding; in other words, one with skill in the art will appreciate that the physical joining of work pieces is not actually required. Likewise, the disclosure herein is meant to include brazing and soldering operations, and the training of brazing and soldering techniques. The present disclosure includes all continuous manual process in which the tracking of position and orientation of a work implement is important from a quality, or training, perspective. Furthermore, the system (100) is applicable to all types of manual welding processes. Each of the components of the system (100), as well as a method for using the system (100), will be discussed in detail below.

Referring specifically now to FIG. 1, a welding gun (200) is shown in proximity to a weld joint (WJ) defined by a first work piece (W1) and a second work piece (W2). The welding gun (200) has a gun axis (210), a gun tip (220), a handle (230), and a target (240). As used throughout this specification, the term welding gun (200) includes welding torches and welding electrode holders for both consumable and non-consumable electrodes. For example, in a shielded metal arc welding process (SMAW), the welding gun (200) would refer to the electrode holder and the gun tip (220) would refer to the consumable electrode. As seen in FIGS. 1-3, the gun axis (210) is an imaginary line extending through the center of the welding gun (200). For many types of welding guns (200) the gun axis (210) will coincide with the gun tip (220).

As seen in FIGS. 1-3, in one embodiment, the target (240) is mounted on the welding gun (200). However, one with skill in the art will appreciate that the target (240) could be integral to the welding gun (200). By way of example only, and not limitation, the target (240) may be built into the handle (230). The target (240) utilized will be specified according to the imaging system (300) requirements for accurate recognition, which will be discussed in more detail below. In some embodiments, the target (240) may be active (e.g., lighted) or passive (e.g., not lighted), depending on the imaging system (300). In one particular embodiment, the target (240) includes a non-repeating geometric visual component (260), as seen best in FIG. 1. To illustrate what is meant by non-repeating, the letter “A” would be a suitable non-repeating geometric visual component (260), whereas the letter “X” would not be a suitable non-repeating geometric visual component (260). By way of example only, the non-repeating geometric visual component (260) may be a sticker, a series of stickers, a series of projections, a series of depressions, or a pattern of lights, all of which include non-repeating geometric shapes or patterns. The non-repeating geometric visual component (260) allows the imaging system (300) to correctly identify the target (240) orientation at all times. This is especially important for imaging systems (300) that utilize only one camera (310).

Referring again to FIGS. 1-3, the system (100) includes an imaging system (300) remotely positioned from the welding gun (200) to capture a plurality of images of the target (240) as the welding gun traverses the weld joint (WJ) while making a weld. In one particular embodiment, the imaging system (300) includes at least one digital camera (310) and a filter (320). By way of example, and not limitation, the at least one digital camera (310) may be a high frame rate, complementary metal-oxide-semiconductor (CMOS) digital camera, or a high frame rate, charge-coupled device (CCD) digital camera. However, one with skill in the art will recognize that virtually any type of high frame rate digital camera may be utilized so long as the camera can accurately capture a plurality of images of the target (240). Preferably, the at least one digital camera (310) is capable of capturing black and white images.

During welding, the at least one digital camera (310) is capturing images of the target (240) while a welding arc is present. The light produced by the welding arc and saturates the imaging element of the at least one digital camera (310) and causes an effect called blooming. As a result of blooming, the images captured will lack clear detail, and thus the accuracy of the captured images of the target (240) will be compromised. To combat the blooming effect, in one particular embodiment, the target (240) includes a light emitting component (250) that emits light of a predetermined wavelength. Further, the filter (320) is constructed in such a way that it will only accept light corresponding to the predetermined wavelength emitted by the light emitting component (250). Thus, the filter (320) operates to block out the light associated with the welding arc, while allowing the light associated with the light emitting component (250) to pass through. By way of example, and not limitation, the light emitting component (250) may be an infrared light source, such as a high-output infrared LED. As mentioned above, the light emitting component (250) will emit light of a predetermined wavelength and the filter (320) will be selected to accept light corresponding to the predetermined wavelength emitted by the light emitting component (250). Generally, weld light radiation is concentrated in the UV to visible light frequency range, which corresponds to a wavelength range of about 380 nm to 750 nm. Thus, to filter out most of the weld light radiation, the light emitting component (250) may emit light in the IR-A band, which corresponds to a wavelength range of about 700 nm to about 1400 nm, and the filter (320) selected to accept light within the IR-A band.

Still referring to FIGS. 1-3, the system (100) includes a processor (400) in communication with the imaging system (300). The processor (400) analyzes and processes the plurality of images of the target (240) and calculates a plurality of position and orientation characteristics associated with the welding gun (200). Although the term processor (400) is used singularly throughout this specification, the processor (400) may include multiple components, such as multiple computers and software programs, which may be located remotely. Preferably, the imaging system (300) and the processor (400) are in communication via a high-speed connection, such as Ethernet, cameralink, or IEEE 1394 to sample images at adequate frequencies to accurately describe welder motions.

In one particular embodiment, the processor (400) includes a computer running an optical software program to process the plurality of images of the target (240) to generate raw distance and position data associated with the target (240) and a conversion software program to transform the raw distance and position data into a plurality of position and orientation characteristics associated with the welding gun (200). Alternatively, the processor (400) may include two computers, with a first computer running the optical software program to generate the raw distance and position data associated with the target (240), and a second computer in communication with the first computer that runs the conversion software program to transform the raw distance and position data into a plurality of position and orientation characteristics associated with the welding gun (200).

The optical software program may be virtually any optical program that is capable of providing accurate distance and position measurements in 3-dimensional space. Notably, the optical software program should be able to track and measure movements along an X-axis, a Y-axis, and a Z-axis, as well as the ability to track and measure roll, pitch, and yaw rotations. One such optical software program is CortexVision, available from Recognition Robotics, Inc. The CortexVision software is designed to mimic human visual and cognitive recognition. In doing so, the CortexVision software uses algorithms to recognize a digital image of a taught object in flexible environments. Thus, the CortexVision software allows a taught object to be recognized, measured, and the taught object's position determined in precise coordinates in any orientation.

In order for the CortexVision software to accurately track and measure the position and movement of the target (240), the software must first learn the target (240), which will then become the “taught object.” The software that transforms the raw data into weld parameters needs to relate the “taught object” position to the weld joint (WJ) position and orientation as well as its position and orientation on the welding gun (200). As such, a calibration process should be performed. The calibration process serves to zero the positioning of the target (240) to create a frame of reference that allows the software to accurately calculate the distance and position data associated with the target (240) when an actual run is performed. For example, a calibration fixture may be utilized to hold the welding gun (200), and thus the target (240), in a known position and orientation relative to the imaging system (300). The calibration process may also be used to register the position of the work piece(s) relative to the imaging system. A user may then initialize the imaging system (300) and processor (400) to begin collecting the raw distance and position data associated with the target (240). Next, the user may proceed to make a trial run along the weld joint (WJ) to begin collecting data. In making the trial run, the user may actually create a weld or simply perform a “dry run” without actually welding. The user will then terminate the trial run data collection process.

The next component of the processor (400) is a conversion software program. The conversion software program performs a series of mathematical operations on the raw data collected by the optical software program. Specifically, the conversion software program uses the raw data collected by the optical software program to calculate a plurality of position and orientation characteristics associated with the welding gun (200) relative to the component being welded. The plurality of position and orientation characteristics associated with the welding gun (200) may include at least one of the following characteristics: a work angle (WA), a travel angle (TA), a standoff distance (SD), a travel speed (TS), and a weave pattern (WP). These characteristics can substantially affect the quality, appearance, and properties of various types of manual welds.

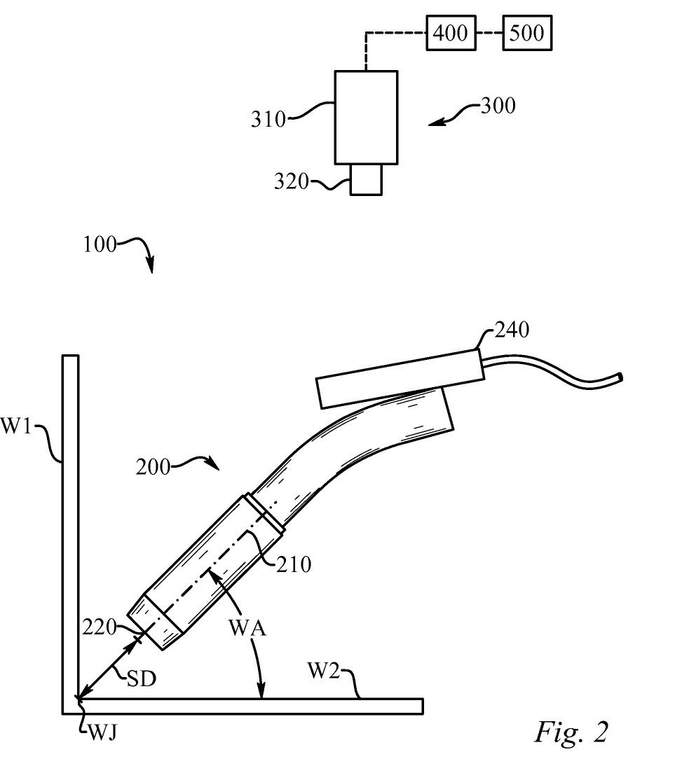

One with skill in the art will be familiar with the above-mentioned characteristics; however, an explanation of each will now be given. Referring to FIG. 2, the work angle (WA) of the welding gun (200) is shown. The work angle (WA) is the angle of the welding gun (200) with respect to the base work piece. Stated another way, the work angle (WA) is the angle at which the gun tip (220) is pointed at the weld joint (WJ) measured from the base work piece. For example, when the weld joint (WJ) is a lap joint or a T-joint, the work angle (WA) should be about 45 degrees, whereas for a butt joint the work angle (WA) should be about 90 degrees. Thus, as seen in FIG. 2, for making a fillet weld on a first work piece (W1) and a second work piece (W2) of equal thickness, the work angle (WA) should be approximately 45 degrees. In multiple-pass fillet welding, the work angle (WA) is important. For instance, when undercuts develop in the vertical section of the fillet weld, the work angle (WA) often should be adjusted such that the gun tip (220) is directed more toward the vertical section.

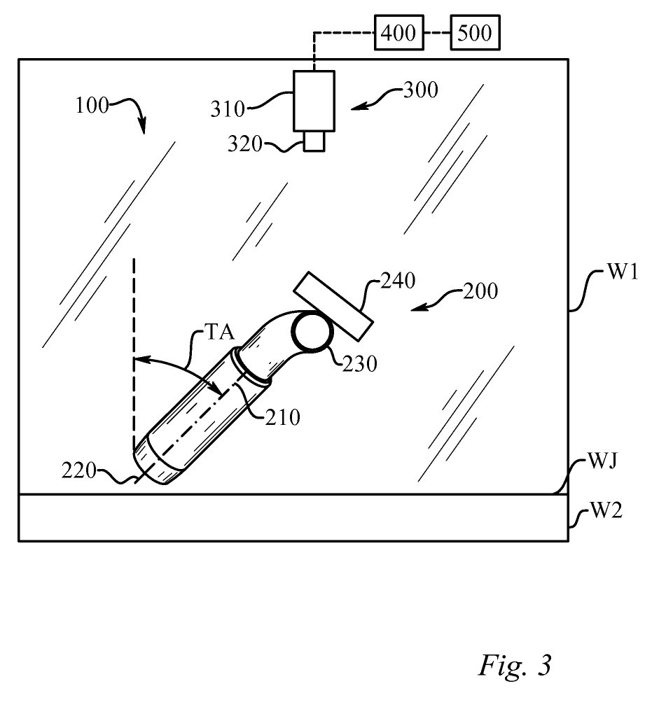

With reference now to FIG. 3, the travel angle (TA) of the welding gun (200) is shown. The travel angle (TA) is the angle of the welding gun (200) measured from the vertical in the direction of welding. The travel angle (TA) is also commonly referred to as the torch angle. Although FIG. 3 shows the travel angle (TA) at approximately 45 degrees, in typical welding processes the travel angle (TA) is between about 5 and 25 degrees. Furthermore, the travel angle (TA) may be a push angle or a pull angle. A push angle refers to when the welding gun (200) is behind the welding arc or weld pool when welding in a particular direction. Conversely, a pull angle refers to when the welding gun (200) is in front of the welding arc or weld pool when welding in a particular direction. FIG. 3 illustrates a pull angle as the weld is being made along the weld joint (WJ) from left to right. The travel angle (TA) can affect the depth of weld penetration and the amount of weld buildup, as well as the amount of spatter generated when welding.

Referring now to FIG. 2, the standoff distance (SD) is illustrated. The standoff distance (SD) is defined by the distance between the welding gun tip (220) and the weld joint (WJ). The standoff distance (SD) is also commonly referred to as the contact tip-to-work distance. Variation in the standoff distance (SD) can affect the creation of the weld. For example, a standoff distance (SD) that is too short can lead to an increase in the weld heat, greater penetration, and a decrease in weld buildup. On the other hand, a standoff distance (SD) that is too long can result in a reduction in weld heat, penetration, and fusion, as well as an increase in weld buildup.

As its name suggests, travel speed (TS) refers to the speed at which the welding gun (200), specifically the gun tip (220), travels along the weld joint (WJ) when welding. The travel speed (TS) can affect the size, shape, and integrity of a weld. The weave pattern (WP) refers to the pattern in which a welder manipulates the welding gun (200), and hence the gun tip (220), when creating a weld and can affect several weld properties. For example, the weave pattern (WP) influences penetration, buildup, width, and integrity of the weld.

In addition to the above-mentioned characteristics, there are other variables and characteristics associated with the welding process that affect the creation of a manual weld. For purposes of this disclosure, such other variables and characteristics will be referred to as a plurality of arc parameters. The plurality of arc parameters include a welding current (I), a welding voltage (V), a wire feed speed (WFS), and an arc length (AL). One with skill in the art will recognize that the electrical energy utilized for welding may be a constant current power source or a constant voltage power source. The plurality of arc parameters are interrelated and also affect the welding process. For example, in gas metal arc welding (GMAW, which is commonly referred to as MIG welding) with a constant voltage power source the welding current (I) is determined by wire feed speed (WFS) and standoff distance (SD), and arc length (AL) is determined by the power source voltage level (open circuit voltage). The rate at which the gun tip (220) melts off is automatically adjusted for any slight variation in the standoff distance (SD), wire feed speed (WFS), or welding current (I) pick-up in the gun tip (220). For example, if the standoff distance (SD) shortens, the arc voltage will momentarily decrease and welding current (I) will be increased to melt back the gun tip (220) to maintain the proper arc length (AL). The reverse will occur to counteract a lengthening of the standoff distance (SD).

In one embodiment of the system (100), a welding power source is in communication with the processor (400). In such an embodiment, the processor (400) receives data corresponding to the arc parameters, namely, the welding current (I), the welding voltage (V), and the wire feed speed (WFS) during the creation of a weld. After receiving the welding current (I), welding voltage (V), and wire feed speed (WFS) data, the processor (400) may calculate the arc length (AL) using mathematical operations known to those with skill in the art.

The final component of the system (100) is a display (500). The display (500) is in communication with the processor (400) and is configured to illustrate at least one of the plurality of position and orientation characteristics of the welding gun (200). By way of example, and not limitation, the display (500) may be a standard computer monitor that is capable of receiving and displaying the data output from the processor (400). Further, the display (500) may be incorporated into a welder's helmet, goggles, gloves, or may be projected onto the work pieces. Although this specification refers to a single display (500), the system (100) may include more than one display (500).

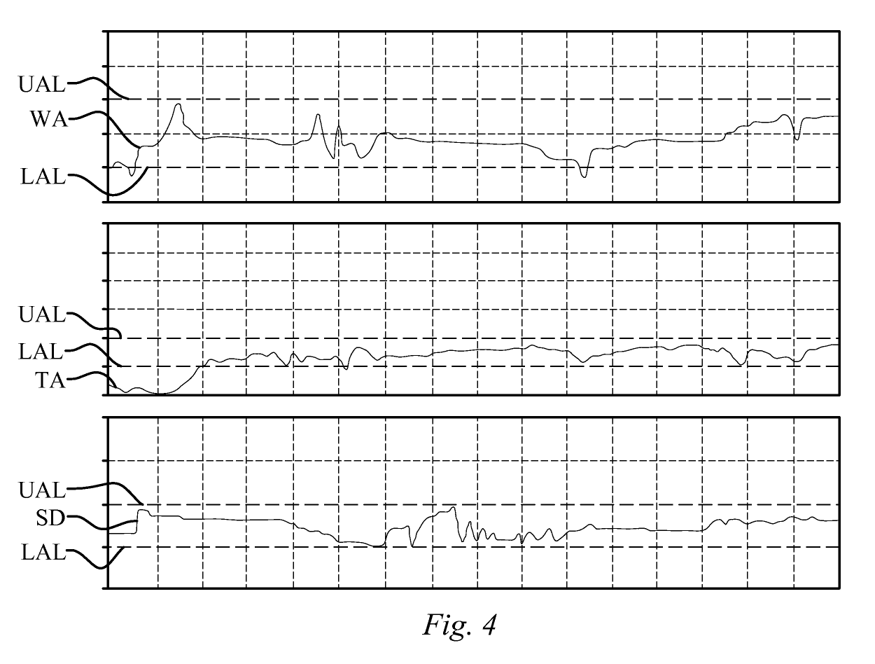

As mentioned above, the display (500) illustrates at least one of the plurality of position and orientation characteristics of the welding gun (200) during creation of a weld, or even in a “dry-run” scenario where the welding gun (200) is manipulated, but no weld is made. Thus, the display (500) serves as a tool for providing visual feedback of the position and orientation characteristics of the welding gun (200). In one embodiment, the plurality of position and orientation characteristics of the welding gun (200) are shown on the display (500) in a graphical format, as seen in FIG. 4.

In another embodiment, the display (500) illustrates at least one of the plurality of arc parameters selected from the group of a welding current (I), a welding voltage (V), a wire feed speed (WFS), and an arc length (AL). Thus, the display (500) may also provide visual feedback corresponding to the plurality of arc parameters during the welding process.

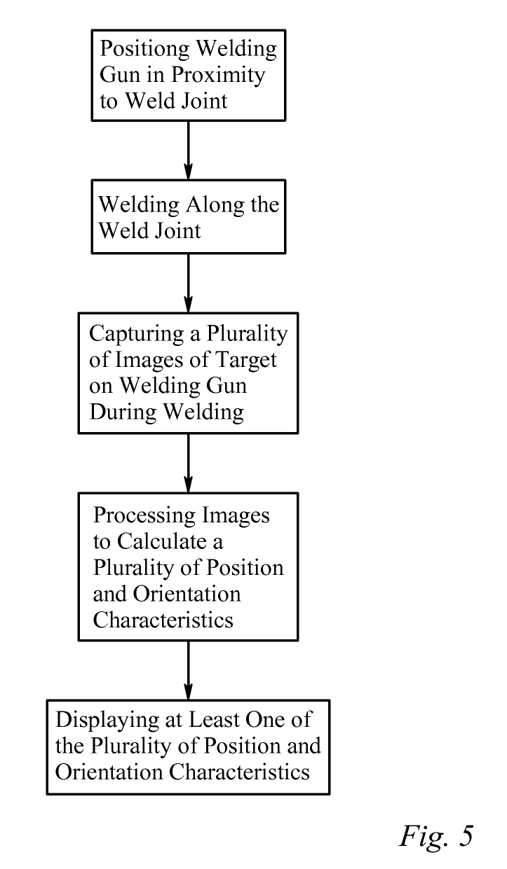

Now that the system (100) has been described in detail, the method associated with using the system (100) will now be discussed. A basic flow chart of the general method is shown in FIG. 5. As a starting point, it should be noted that the method is a non-contact method for monitoring and characterizing the creation of a manual weld. The term non-contact refers to the fact that there is no physical contact between a welder and the system (100), other than the welder's holding and manipulation of the welding gun (200). Thus, the welder can create a manual weld while the system (100) monitors and characterizes the welding process without interfering with the welder.

In one embodiment, the method begins by positioning a welding gun (200) in proximity to a weld joint (WJ), as seen in FIG. 1. The weld joint (WJ) is defined by a first work piece (W1) and a second work piece (W2). Although a corner joint is shown throughout the figures, the method may be performed with any type of weld joint. In positioning the welding gun (200), the gun tip (220) is nominally located a standoff distance (SD) from the weld joint (WJ). As previously described, the welding gun (200) includes a target (240), which may be mounted on the welding gun (200) or integral thereto.

The next step in the method is welding the first work piece (W1) and the second work piece (W2) along the weld joint (WJ) with the welding gun (200). As mentioned above, the system (100), and thus the method, may also be utilized for “dry-run” scenarios. Therefore, the step of welding does not require an actual weld to be created. In fact, all that the welding step requires is that the welding gun (200) be traversed along the weld joint (WJ).

During the welding step, a number of other steps may be occurring simultaneously. One such step is capturing remotely a plurality of images of the target (240) as the welding gun (200) traverses the weld joint (WJ). As previously noted, the system (100) includes an imaging system (300) to capture a plurality of images of the target (240). In one embodiment, the plurality of images of the target (240) are captured by at least one digital camera (310). The at least one digital camera (310) is positioned remotely from the welding gun (200) and target (240). The distance between the digital camera (310) and the target (240) will somewhat depend on the amount of lens zoom, the size of the work area, as well as the size of the target (240).

Another step that may occur during welding is the processing of the plurality of remotely captured images of the target (240) and calculating a plurality of position and orientation characteristics associated with the manipulation of the welding gun (200). In this step, the processor (400) will complete the following steps: (a) receiving the plurality of remotely captured images of the target (240); (b) analyzing the plurality of images of the target (240) to determine the gather raw data corresponding to the movement and manipulation of the target (240) on the X-axis, Y-axis, and Z-axis, as well as the target's (240) roll, pitch, and yaw rotations; and (c) calculating a plurality of position and orientation characteristics of the welding gun (200) by performing mathematical operations on the gathered raw data. As previously noted, the plurality of position and orientation characteristics calculated during welding may include at least one characteristic selected from the group of a work angle (WA), a travel angle (TA), a standoff distance (SD), a travel speed (TS), and a weave pattern (WP).

When the plurality of position and orientation characteristics associated with the manipulation of the welding gun (200) during welding are calculated, the next step of the method is displaying at least one of the plurality of position and orientation characteristics associated with the manipulation of the welding gun (200). The plurality of position and orientation characteristics may be shown on one or more displays (500), such as a computer monitor or a television, and may be shown in a graphical format.

In one particular embodiment, the method further includes the step of acquiring a plurality of arc parameters during welding as the welding gun (200) traverses the weld joint (WJ). The plurality of arc parameters acquired during welding may include a welding current (I), a welding voltage (V), and a wire feed speed (WFS). As mentioned above, during the welding step, the processor (400) receives data from the welding power source corresponding to the plurality of arc parameters, namely, the welding current (I), the welding voltage (V), and the wire feed speed (WFS). After receiving and processing this data, the processor (400) may calculate the arc length (AL) by executing mathematical operations known to those with skill in the art. However, in “dry-run” scenarios, a virtual power source may be provided to simulate the plurality of arc parameters. In such an embodiment, the method and system (100) may be effectively utilized for training without wasting power and materials.

Regardless of whether an actual power source or a virtual power source is utilized, the method may also include the step of displaying at least one of the plurality of arc parameters or the arc length (AL). The plurality of arc parameters or the arc length (AL) may be shown on one or more displays (500), as previously disclosed.

In yet another embodiment, the method includes the steps of: (a) storing the plurality of position and orientation characteristics calculated during welding; and (b) comparing the stored plurality of position and orientation characteristics calculated during welding to a plurality of predefined acceptance limits of position and orientation characteristics to ensure quality control, or even to validate the weld. In this embodiment, the processor (400) includes storage means, such as a data folder on a computer hard drive. The storage means may also include the plurality of predefined acceptance limits of position and orientation characteristics. The predefined acceptance limits of position and orientation characteristics may correspond to established standard operating procedures for different types of welds and weld joints (WJ). The stored plurality of position and orientation characteristics calculated during welding and the plurality of predefined acceptance limits of position and orientation characteristics may be compared by displaying an upper acceptance limit (UAL) and a lower acceptance limit (LAL) in conjunction with a particular position and orientation characteristic on the display (500), as seen in FIG. 4. This particular embodiment of the method allows a weld to be validated when the plurality of position and orientation characteristics are within the predefined acceptance limits. Furthermore, the comparison may indicate portions along the weld that were created outside of the predefined acceptance limits of position and orientation characteristics, indicating defect locations along the weld. As such, this particular method can be used as a quality control tool to reduce costly non-destructive testing and repair. Moreover, in training scenarios, such a method could reduce the need for destructive testing of welds created by trainees.

In still another embodiment, the method includes the steps of: (a) storing the plurality of arc parameters acquired during welding; and (b) comparing the stored plurality of arc parameters acquired during welding to a plurality of predefined acceptance limits of arc parameters to ensure weld quality, or even to validate the weld. As just described, the processor (400) includes storage means, such as a data folder on a computer hard drive. The storage means may also include the plurality of predefined acceptance limits of arc parameters. The predefined acceptance limits of arc parameters may correspond to established standard operating procedures for creating different types of manual welds. The stored plurality of arc parameters acquired during welding and the plurality of predefined acceptance limits of arc parameters may be compared by displaying an upper acceptance limit (UAL) and a lower acceptance limit (LAL) in conjunction with a particular arc parameter on the display (500). This particular embodiment of the method also allows the weld to be validated when the plurality of arc parameters are within the predefined acceptance limits, and provides similar benefits as the preceding embodiment.

Although the storing of the plurality of position and orientation characteristics calculated during welding and the plurality of arc parameters acquired during welding, and the comparing of these values with a plurality of predefined acceptance limits were disclosed separately, the method may store and compare both sets of data to indicate the completion of an acceptable weld, or even to validate the weld. This particular embodiment will provide a more robust validation by ensuring that both the plurality of position and orientation characteristics and the plurality of arc parameters are within the respective predefined acceptance limits.

Along those same lines, in another embodiment, the method may include the step of processing the plurality of position and orientation characteristics calculated during welding and the plurality of arc parameters acquired during welding to estimate a weld cross-section geometry, metallurgy, or resultant weld shape in real-time. As previously discussed, the plurality of position and orientation characteristics and the plurality of arc parameters can greatly affect a number of weld properties. In this step, the processor (400) utilizes the known ways in which the plurality of position and orientation characteristics and the plurality of arc parameters affect weld properties to provide an estimate of the weld cross-section, metallurgy, or resultant weld shape. Furthermore, the estimated weld cross-section, metallurgy, or resultant weld shape may be illustrated on the display (500). Such an embodiment is especially useful in welder training as providing visual feedback on how the manipulation of the welding gun (200) influences weld cross-section, metallurgy, or resultant weld shape. In one embodiment the associated metallurgy may be determined utilizing the methods disclosed in U.S. provisional application Ser. No. 60/925,464 filed on Apr. 20, 2007 and titled “Remote High-Performance Computing Material Joining and Material Forming Modeling System and Method,” as well as the related international application number PCT/US2008/061032, both of which are incorporated entirely herein.

In another embodiment, the method includes the step of providing real-time feedback during welding. The real-time feedback may be for at least one of the plurality of position and orientation characteristics calculated during welding, or for at least one of the plurality of arc parameters acquired during welding. The provision of real-time feedback may take on various forms. As previously discussed, the plurality of position and orientation characteristics and the plurality of arc parameters may be illustrated on a display (500) in real-time. Another form of real-time feedback may be an audible alarm. For example, if the travel angle (TA) exceeds an upper or lower limit, an audible alarm will sound. Still another form of real-time feedback may be a tactile alarm. For instance, if a welder begins using a travel angle (TA) that is too steep for the particular welding process, a tactile alarm, such as vibrations or a percussive signal, may be communicated via the welding gun (200), an armband, a power cable, or by other means to inform the welder that a corrective action is required. Furthermore, in “dry-run” training scenarios, real-time feedback may be provided by providing displays (500) within a welding helmet via a heads-up display with transparent optics such that the trainee is capable of monitoring their manipulation of the welding gun (200) and taking corrective action when necessary. Such embodiments allow a welding trainee to practice their technique more perfectly and to learn the proper technique without picking up bad welding habits along the way.

In still another embodiment, the method may include providing interactive instructions for improvement or providing an analysis of the welding process. For example, the processor (400) may have an option to analyze the real-time data collected during welding. In analyzing the real-time data, the processor (400) may assign a score, grade, or confidence measure associated with that particular welding process. Additionally, the processor (400) may analyze the real-time data to determine whether a trainee has flaws in their welding technique, and provide tips for improving or correcting those flaws.

In yet another embodiment, the method may include utilizing the collected real-time data as feedback to the welding power source. The welding power source will attempt to compensate for human movements affecting the desired arc welding properties by automatically adjusting the the plurality of arc parameters in real-time. Such an embodiment may utilize known or predefined acceptance limits of the welding position and orientation characteristics and a welding power source capable of dynamically adjusting the plurality of arc parameters. For example, if the standoff distance (SD) shortens beyond a predefined acceptance limit, the arc voltage will momentarily decrease and the welding current (I) will be increased to melt back the gun tip (220) such that the standoff distance (SD) is once again within the predefined acceptance limit. In a further example, if the travel speed (TS) were to decrease, the wire feed speed (WFS) would be automatically decreased to maintain a consistent weld size.

In yet another embodiment of the system (100) in which the welding power source automatically changes to accommodate human movements, or errors during welding, during semi-automatic MIG welding the welding power source automatically increases the wire feed speed if the system (100) determines that the travel speed (TS) is too slow. Further, the system (100) can identify if the user is welding in the wrong transfer mode, i.e., globular versus spray mode, by monitoring at least one of the plurality of arc parameters and sensing the transfer mode and automatically adjusting the welding power source to automatically change the welding power source parameters. In still a further embodiment, when stick welding using an electrode holder, if the user sets the welding power source current too low, the welding power source will sense an impending short circuit from at least one of the plurality of arc parameters and automatically increase the welding power source current. Alternatively, in another embodiment incorporating at least one additional external sensor, if the user sets the welding power source current too high then the additional external sensor will detect the electrode temperature and automatically decrease the welding power source current.

Having fully described the method and system (100) for monitoring and characterizing the creation of a manual weld, it may thus be appreciated that the method and system (100) offer substantial advantages. One immediately recognizable advantage is the fact that the method and system (100) may be utilized as a welder training tool or as a tool for manual weld process monitoring and control. For welder training applications, the following benefits are achieved: (a) time savings by teaching perfect weld practice immediately; (b) material savings by accelerating welding skill development and by performing “dry-run” trials before moving on to creating actual welds; and (c) reducing or eliminating the need for destructive testing of trainee welds. In actual welding applications, the method and system (100) may be utilized to validate welds without non-destructive testing, to ensure that a weld is created within predefined quality control acceptance limits, and to help identify potential defect locations.

Further, the display (500) may provide suggested corrective actions to the user when the predefined acceptance limits of position and orientation characteristics are not acceptable. This real-time feedback allows a user to quickly take corrective action based upon the recommendation of the system. One example of such feedback would be the process of displaying at least one red light, yellow light, green light feedback system to the user. For instance, a green light would indicate that the particular parameter is within the acceptance limits, a yellow light would indicate that the particular parameter is approaching the bounds of the acceptance limits, and a red light would indicate that the particular parameter is beyond the acceptance limits. In one embodiment this system is used to provide feedback to the user of multiple parameters. For instance, in one embodiment a parameter that is being monitored is shown in each corner of the display (500). Alternative embodiments substitute feedback systems incorporating numbers, colors, graphs, pictures, or arrows instead of the colored lights discussed above. Such a feedback system is not limited to the position and orientation characteristics, but may also include the arc parameters.

Numerous alterations, modifications, and variations of the preferred embodiments disclosed herein will be apparent to those skilled in the art and they are all anticipated and contemplated to be within the spirit and scope of the method and system (100) for monitoring and characterizing the creation of a manual weld. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the method and system (100) are described herein, it is to be understood that the practice of such additional modifications and variations and the equivalents thereof, are within the spirit and scope of the method and system (100) as defined in the following claims. The corresponding structures, materials, acts, and equivalents of all means or step plus function elements in the claims below are intended to include any structure, material, or acts for performing the functions in combination with other claimed elements as specifically claimed.

We claim:

1. A non-contact method for monitoring and characterizing the creation of a manual weld comprising:
a) positioning a welding gun (200) in proximity to a weld joint (WJ) defined by a first work piece (W1) and a second work piece (W2), wherein the welding gun (200) has a gun tip (220) nominally located a standoff distance (SD) from the weld joint (WJ), and a target (240);
b) welding the first work piece (W1) and the second work piece (W2) along the weld joint (WJ) with the welding gun (200);
c) capturing remotely a plurality of images of the target (240) during welding as the welding gun (200) traverses the weld joint (WJ);
d) processing the plurality of remotely captured images of the target (240) to calculate a plurality of position and orientation characteristics associated with the manipulation of the welding gun (200) during welding; and
e) displaying at least one of the plurality of position and orientation characteristics associated with the manipulation of the welding gun (200) during welding.

2. The method of claim 1, wherein the plurality of images of the target (240) are captured by at least one digital camera (310).

3. The method of claim 1, wherein the plurality of position and orientation characteristics calculated during welding includes at least one characteristic selected from the group of a work angle (WA), a travel angle (TA), a standoff distance (SD), a travel speed (TS), and a weave pattern (WP).

4. The method of claim 1, further including the step of acquiring a plurality of arc parameters during welding as the welding gun (200) traverses the weld joint (WJ).

5. The method of claim 4, wherein the plurality of arc parameters acquired during welding includes at least one parameter selected from the group of a welding current (I), a welding voltage (V), and a wire feed speed (WFS).

6. The method of claim 5, further including the step of automatically adjusting at least one of the plurality of arc parameters to compensate for variations in at least one of the plurality of position and orientation characteristics.

7. The method of claim 5, further including the steps of:
(a) processing the plurality of acquired arc parameters to calculate an arc length (AL); and
(b) displaying at least one of the plurality of arc parameters or the arc length (AL).

8. The method of claim 1, further including the steps of:
a) storing the plurality of position and orientation characteristics calculated during welding; and
b) comparing the stored plurality of position and orientation characteristics calculated during welding to a plurality of predefined acceptance limits of position and orientation characteristics to validate the weld.

9. The method of claim 4, further including the steps of:
a) storing the plurality of arc parameters acquired during welding; and
b) comparing the stored plurality of arc parameters acquired during welding to a plurality of predefined acceptance limits of arc parameters to validate the weld.

10. The method of claim 1, further including the step of providing real-time feedback for at least one of the plurality of position and orientation characteristics calculated during welding.

11. The method of claim 1, further including the step of providing real-time feedback for at least one of the plurality of arc parameters acquired during welding.

12. The method of claim 4, further including the step of processing the plurality of position and orientation characteristics calculated during welding and the plurality of arc parameters acquired during welding to estimate at least one of a weld cross-section geometry, a metallurgy of the weld, or a resultant weld shape.

13. The method of claim 1, further including the steps of emitting infrared radiation in the IR-A band from the target (240) and filtering the plurality of images of the target (240) to only permit the passage of infrared radiation in the IR-A band.

14. A system (100) for monitoring and characterizing the creation of a manual weld comprising:
a) a welding gun (200) having a gun axis (210), a gun tip (220), a handle (230), and a target (240);
b) an imaging system (300) remotely positioned from the welding gun (200) to capture a plurality of images of the target (240);
c) a processor (400) in communication with the imaging system (300) that processes the plurality of images of the target (240) and calculates a plurality of position and orientation characteristics associated with the welding gun (200); and
d) a display (500) in communication with the processor (400) for illustrating at least one of the plurality of position and orientation characteristics.

15. The system (100) of claim 14, wherein the imaging system (300) includes at least one digital camera (310) and a filter (320).

16. The system (100) of claim 15, wherein the target (240) includes a light emitting component (250) that emits light of a predetermined wavelength and the filter (320) only accepts light corresponding to the predetermined wavelength emitted by the light emitting component (250).

17. The system (100) of claim 16, wherein the light emitting component (250) emits infrared radiation in the IR-A band and the filter (320) only passes infrared radiation in the IR-A band.

18. The system (100) of claim 14, wherein the target (240) is specific to the imaging system (300).

19. The system (100) of claim 14, wherein the plurality of position and orientation characteristics includes at least one characteristic selected from the group of a work angle (WA), a travel angle (TA), a standoff distance (SD), a travel speed (TS), and a weave pattern (WP).

20. The system (100) of claim 14, wherein the plurality of position and orientation characteristics includes at least two characteristics selected from the group of a work angle (WA), a travel angle (TA), a standoff distance (SD), a travel speed (TS), and a weave pattern (WP).

21. The system (100) of claim 14, wherein the display (500) further illustrates at least one of a plurality of arc parameters selected from the group of a welding current (I), a welding voltage (V), a wire feed speed (WFS), and an arc length (AL).

22. The system (100) of claim 15, wherein the processor (400) receives at least one of the plurality of arc parameters and at least one of the plurality of position and orientation characteristics, and the processor (400) automatically adjusts at least one of the plurality of arc parameters to compensate for variations in at least one of the plurality of position and orientation characteristics.
